(19) United States
(12) Patent Application Publication
(10) Pub. No.: US 2011/0304264 A1
(43) Pub. Date: Dec. 15, 2011

(54) SURFACE-MODIFIED SILICATE FLUORESCENT SUBSTANCES

(75) Inventor: Holger Winkler, Darmstadt (DE)

(73) Assignee: Merck Patent Gesellschaft Mit Beschrankter Haftung, Darmstadt (DE)

(21) Appl. No.: 13/133,272

(22) PCT Filed: Nov. 10, 2009
(86) PCT No.: PCT/EP2009/008002

§ 371 Date: Aug. 29, 2011

(30) Foreign Application Priority Data
Dec. 8, 2008 (DE) 10 2008 060 680.4

(51) Int. Cl. H05B 33/14; C09K 11/79; F21V 9/16; B05D 5/06; H01J 1/62; C09K 11/02; C09K 5/00

(52) U.S. Cl. 313/504; 252/71; 427/157; 313/483; 362/84; 313/503

(57) ABSTRACT

The invention relates to surface-modified phosphor particles based on luminescent particles which comprise at least one luminescent compound selected from the group of the silicate phosphors, where at least one coating having a thermal conductivity of <20 W/mK and at least one second coating having a thermal conductivity of >20 W/mK have been applied to the luminescent particles, and to a production process.

The invention relates to surface-modified phosphor particles based on luminescent particles of silicate phosphors, where at least one coating having a thermal conductivity of <20 W/mK and at least one second coating having a thermal conductivity of >20 W/mK are applied to the luminescent particles, and to a production process and to the use thereof as conversion phosphor in white LEDs.

The heat formed during operation of LED chips results in the entire LED heating up. Although the heat can be dissipated to a certain extent, warming of the phosphors inevitably occurs, however. In general, a phosphor is less efficient at a higher operating temperature than at lower temperature. This behaviour, known as “thermal quenching” to the person skilled in the art, stems from the fact that lattice vibrations in the phosphor are stimulated with increasing temperature, resulting in non-radiative processes occurring to an increased extent, i.e. the fluorescence of the phosphor is attenuated or quenched. The extent of the thermal quenching depends on the chemical composition of the phosphor: phosphors such as LuAG:Ce exhibit virtually no thermal quenching whereas orthosilicates have thermal quenching, so that the fluorescence at working temperatures of 150° C. drops to about 50% of the fluorescence at room temperature. For use of orthosilicates, in particular, in power LEDs, it would be advantageous if thermal quenching could be reduced.

JP-4304290 A discloses a phosphor which is provided with a diamond coating in order to reduce thermal quenching and improve the chemical stability.

WO 91/10715 describes a phosphor, such as zinc silicate or calcium halophosphate, which is provided with a silica coating and an alumina coating.

WO 99/27033 describes a phosphor particle, such as copper sulfide, zinc sulfide or cadmium sulfide, which is provided with a diamond-like carbon coating. These phosphor particles may furthermore have transparent inorganic or organic coatings.

The object of the present invention was to coat silicate phosphors in such a way that the above-mentioned problem of thermal quenching is reduced.

Surprisingly, it has now been found that the effects of thermal quenching can be reduced by coating the silicate phosphors in accordance with an onion-skin model (see FIG. 2).

The present invention thus relates to surface-modified phosphor particles based on luminescent particles which comprise at least one luminescent compound selected from the group of the silicate phosphors, where at least one coating having a thermal conductivity of <20 W/mK and at least one second coating having a thermal conductivity of >20 W/mK have been applied to the luminescent particles.

The silicate phosphor is firstly provided with a first coating of a material which is optically transparent and has low thermal conductivity. The second coating is then built up from a material which is likewise optically transparent and has high thermal conductivity.

If heat emanating from the LED chip is fed to the phosphor, the second coating is able to divert the heat around the phosphor. The first coating, which is located between the phosphor and the second coating, prevents the heat being able to enter the phosphor. As a result, the phosphor heats up less and luminesces more brightly.

The thickness of the first coating having a thermal conductivity of <20 W/mK is between 3 and 500 nm; the thickness of the second coating is between 3 and 600 nm.

A further preferred embodiment consists in that the two coatings are built up around the phosphor in a multiple sequence: phosphor—1st coating—2nd coating—1st coating, 2nd coating—1st coating, 2nd coating—1st coating, etc.

The luminescent particles preferably comprise at least one luminescent compound selected from the group

BaᵤSrᵥZn_{w}EuₓSiO₄ (I)

and/or

BaᵤSrᵥCa_{w}EuₓSiO₄ (II)

where u+v+w+x=2.

The first coating preferably comprises nanoparticles and/or layers of oxides of Si, Zr, Ti and/or mixtures thereof. Particular preference is given to a silicon oxide coating since it has a particularly large number of reactive hydroxyl groups available, simplifying further attachment of an organic coating.

The first coating preferably has an amorphous structure and may be porous, reducing the thermal conductivity further, as is known to the person skilled in the art (“polystyrene foam effect”).

The term “porous” is taken to mean the average pore opening on the surface of a material. The coated phosphor surface according to the invention is preferably mesa- or macroporous, where “mesoporous” describes a pore opening of between 2 and 50 nm and “macroporous” describes a pore size of >50 nm.

The thermal conductivity of this coating is preferably between 0.1 and 10 W/mK.

The first and second coatings are preferably substantially transparent, i.e. they must ensure 90% to 100% transparency both for the excitation spectrum and also for the emission spectrum of the conversion phosphors employed in each case. On the other hand, the transparency of the coatings according to the invention for all wavelengths which do not correspond to the excitation and emission wavelengths may also be less than 90% to 100%.

The coated phosphor particles are then provided with a further coating which has a thermal conductivity of >20 W/mK, preferably comprising carbons having a diamond structure or aluminium oxide, zinc oxide, magnesium oxide and/or beryllium oxide. This coating is also carried out by wet-chemical methods or by means of a vapour-deposition process (via CVD or PVD processes). This second coating may also be porous, but preferably consists of a continuous layer or may also consist of nanoparticles. The latter have a diameter of 3 to 100 nm. The thermal conductivity of this coating is preferably between 25 and 2500 W/mK.

Carbon layers having a diamond structure have the advantage that they have particularly high thermal conductivities of up to 2200 W/mK.

The particle size of the phosphor particles according to the invention is between 0.5 μm and 40 μm, preferably between 2 μm and 20 μm.

The coating according to the invention is not inevitably homogeneous, but instead may also be in the form of islands or in droplet form on the surface of the particles.

The phosphor particles coated or surface-modified in this way can also be subjected, in accordance with the invention, to functionalisation in order to match the surface properties to those of the binder. It is known to the person skilled in the art that this facilitates more homogeneous mixing of the phosphor in the binder, improving the applicational properties.

The present invention furthermore relates to a process for the production of a surface-modified phosphor particle, characterised by the following steps:
a. production of a phosphor particle by mixing at least two starting materials and at least one dopant and thermal treatment at a temperature T>150° C.,
b. coating of the phosphor particle with a coating having a thermal conductivity of <20 W/mK in a wet-chemical or vapour-deposition process,
c. application of at least one further coating having a thermal conductivity of >20 W/mK.

The coating of the phosphor particles is particularly preferably carried out by wet-chemical methods by precipitation of the metal, transition-metal or semimetal oxides or hydroxides in aqueous dispersion. To this end, the luminescent particle or the uncoated phosphor is suspended in water in a reactor and coated with the metal oxide or hydroxide by simultaneous metered addition of at least one metal salt and at least one precipitant with stirring.

As an alternative to metal salts, it is also possible to meter in organometallic compounds, for example metal alkoxides, which then form metal oxides or hydroxides by hydrolytic decomposition. Another possible way of coating the luminescent particles is coating via a sol-gel process in an organic solvent, such as, for example, ethanol or methanol. This process is particularly suitable for water-sensitive materials and for acid- or alkali-sensitive substances.

Further methods are, in accordance with the invention, coating with the aid of mixed-bed reactors, adsorption of relatively small, pre-formed particles onto the surface of the materials to be coated, and coating from the gas phase, for example via physical vapour deposition (=PVD) or chemical vapour deposition (=CVD).

The starting materials for the production of the luminescent particles or silicate phosphor particles according to the invention consist, as mentioned above, of the base material (for example salt solutions of barium, strontium or silicon) and at least one dopant, such as europium, cerium, manganese and/or zinc, preferably europium. Suitable starting materials are inorganic and/or organic substances, such as nitrates, carbonates, hydrogencarbonates, phosphates, carboxylates, alcoholates, acetates, oxalates, halides, sulfates, organometallic compounds, hydroxides and/or oxides of the metals, semimetals, transition metals and/or rare earths, which are dissolved and/or suspended in inorganic and/or organic liquids. Preference is given to the use of mixed nitrate solutions and oxide solutions which comprise the corresponding elements in the requisite stoichiometric ratio.

For wet-chemical production of a luminescent particle consisting, for example, of a mixture of barium nitrate, strontium nitrate, highly disperse silicon dioxide, ammonium chloride and europium nitrate hexahydrate solution, the following known methods are preferred:
co-precipitation using an NH₄HCO₃ solution (see, for example, Jander, Blasius Lehrbuch der analyt. u. präp. anorg. Chem. 2002)
Pecchini process using a solution of citric acid and ethylene glycol (see, for example, Annual Review of Materials Research Vol. 36: 2006, 281-331)
Combustion process using urea
Spray drying of aqueous or organic salt solutions (starting materials)
Spray pyrolysis of aqueous or organic salt solutions (starting materials)

In the case of the above-mentioned co-precipitation, which is particularly preferred in accordance with the invention, an NH₄HCO₃ solution is added, for example, to the chloride or nitrate solutions of the corresponding phosphor starting materials, resulting in the formation of the phosphor precursor.

In the Pecchini process, a precipitation reagent consisting of citric acid and ethylene glycol is added, for example, to the above-mentioned nitrate solutions of the corresponding phosphor starting materials at room temperature, and the mixture is subsequently heated. The increase in viscosity results in the formation of the phosphor precursor.

In the known combustion process, for example, the above-mentioned nitrate solutions of the corresponding phosphor starting materials are dissolved in water, the solution is then refluxed, and urea is added, resulting in the slow formation of the phosphor precursor.

Spray pyrolysis is one of the aerosol processes, which are characterised by spraying of solutions, suspensions or dispersions into a reaction space (reactor) heated in various ways and the formation and deposition of solid particles. In contrast to spray drying at hot-gas temperatures <200° C., spray pyrolysis, as a high-temperature process, involves thermal decomposition of the starting materials used (for example salts) and the re-formation of substances (for example oxides or mixed oxides) in addition to evaporation of the solvent.

The 5 process variants mentioned above are described in detail in WO 2007/144060 (Merck), which is incorporated in its full scope into the context of the present application by way of reference.

The surface-modified phosphor particles according to the invention can be produced by various wet-chemical methods by
1) homogeneous precipitation of the constituents, followed by separation of the solvent and single- or multistep thermal aftertreatment, where one of the steps can be carried out in a reducing atmosphere,
2) finely dividing the mixture, for example with the aid of a spraying process, and the solvent is removed, followed by a single- or multistep thermal aftertreatment, where one of the steps can be carried out in a reducing atmosphere, or
3) finely dividing the mixture, for example with the aid of a spray process, and the solvent is removed together with pyrolysis, followed by a single- or multistep thermal aftertreatment, where one of the steps can be carried out in a reducing atmosphere,
4) subsequently coating the phosphors prepared with the aid of methods 1-3 by wet-chemical methods.

The wet-chemical preparation of the phosphor is preferably carried out by the precipitation and/or sol-gel process.

In the thermal aftertreatment mentioned above, it is preferred for the calcination to be carried out at least partly under reducing conditions (for example using carbon monoxide, forming gas, pure hydrogen, mixtures of hydrogen and an inert gas or at least vacuum or oxygen-deficiency atmosphere).

In general, it is also possible to prepare the uncoated phosphors according to the invention by the solid-state diffusion method, although this causes the disadvantages mentioned above.

With the aid of the processes mentioned above, any desired outer shapes of the phosphor particles can be produced, such as spherical particles, flakes and structured materials and ceramics.

The phosphors according to the invention can additionally be excited over a broad range, which extends from about 250 nm to 560 nm, preferably 380 nm to about 500 nm. These phosphors are thus suitable for excitation by UV or blue-emitting primary light sources, such as LEDs or conventional discharge lamps (for example based on Hg).

The present invention furthermore relates to a lighting unit having at least one primary light source whose emission maximum extends in the range from 250 nm to 530 nm, preferably from 380 nm to about 500 nm, where the primary radiation is partly or completely converted into longer-wavelength radiation by the surface-modified phosphors according to the invention. This lighting unit preferably emits white light or light having a certain colour point (colour-on-demand principle).

In a preferred embodiment of the lighting unit according to the invention, the effect of the heat diversion can be augmented further by the double coating if particles of the second coating material are introduced in a concentration of 1 to 20% by weight into the binder (silicone or epoxy resin) surrounding the phosphor. These particles act as thermal conduction pathways and conduct the heat from the second coating away from the phosphor to the surface of the LED (see FIG. 2). The size of the particles is between 30 nm and 1.5 μm.

In a preferred embodiment of the lighting unit according to the invention, the light source is a luminescent indium aluminium gallium nitride, in particular of the formula InᵢGaⱼAlₖN, where 0≦i, 0≦j, 0≦k, and i+j+k=1.

Possible forms of light sources of this type are known to the person skilled in the art. They can be light-emitting LED chips having various structures.

In a further preferred embodiment of the lighting unit according to the invention, the light source is a luminescent arrangement based on ZnO, TCO (transparent conducting oxide), ZnSe or SiC or an arrangement based on an organic light-emitting layer (OLED).

In a further preferred embodiment of the lighting unit according to the invention, the light source is a source which exhibits electroluminescence and/or photoluminescence. The light source may furthermore also be a plasma or discharge source.

The phosphors according to the invention can either be dispersed in a resin (for example epoxy or silicone resin), arranged directly on the primary light source or, depending on the application, arranged remote therefrom (the latter arrangement also includes “remote phosphor technology”). The advantages of remote phosphor technology are known to the person skilled in the art and are revealed, for example, in the following publication: Japanese Journ. of Appl. Phys. Vol. 44, No. 21 (2005), L649-L651.

In a further embodiment, it is preferred for the optical coupling of the lighting unit between the coated phosphor and the primary light source to be achieved by means of a light-conducting arrangement.

This enables the primary light source to be installed at a central location and to be optically coupled to the phosphor by means of light-conducting devices, such as, for example, light-conducting fibres. In this way, lamps matched to the illumination wishes and merely consisting of one or different phosphors, which may be arranged to form a light screen, and a light conductor, which is coupled to the primary light source, can be achieved. In this way, it is possible to position a strong primary light source at a location which is favourable for the electrical installation and to install lamps comprising phosphors which are coupled to the light conductors at any desired locations without further electrical cabling, but instead only by laying light conductors.

The present invention furthermore relates to the use of the phosphors according to the invention for the partial or complete conversion of the blue or near-UV emission from a luminescent diode.

The present invention furthermore relates to the use of the phosphors according to the invention in electroluminescent materials, such as, for example, electroluminescent films (also known as lighting films or light films), in which, for example, zinc sulfide or zinc sulfide doped with Mn²⁺, Cu⁺ or Ag⁺ is employed as emitter, which emit in the yellow-green region. The areas of application of the electroluminescent film are, for example, advertising, display backlighting in liquid-crystal display screens (LC displays) and thin-film transistor (TFT) displays, self-illuminating vehicle licence plates, floor graphics (in combination with a crush-resistant and slip-proof laminate), in display and/or control elements, for example in automobiles, trains, ships and aircraft, or also domestic appliances, garden equipment, measuring instruments or sport and leisure equipment.

The following examples are intended to illustrate the present invention. However, they should in no way be regarded as limiting. All compounds or components which can be used in the compositions are either known and commercially available or can be synthesised by known methods. The temperatures indicated in the examples are always given in ° C. It furthermore goes without saying that, both in the description and also in the examples, the added amounts of the components in the compositions always add up to a total of 100%. Percentage data given should always be regarded in the given connection. However, they usually always relate to the weight of the part-amount or total amount indicated.

### EXAMPLES

### Working Example 1

### Coating of a Phosphor Powder (Sr, Ba)₂SiO₄:Eu with SiO₂ (Generation of Active Hydroxyl Groups)

50 g of the phosphor are dispersed in 750 ml of ethanol at 25° C. 10 ml of tetramethoxysilane are passed in over the course of 5 min with stirring. 70 ml of concentrated ammonia solution are then metered into the dispersion over the course of 30 min, and the mixture is stirred vigorously for a further 30 min. In a further step, 35 ml of tetraethoxysilane are metered into the mixture over the course of 60 min, and the mixture is stirred for a further 3 hours. The solid is separated off by filtration, and the filter cake is washed with ethanol and dried at 200° C. for 24 h.

### Coating of the Phosphor from Example 1 with a Second Layer Having a Thermal Conductivity of >20 W/mK

### Working Example 2

### Coating with Zinc Oxide

50 g of the solid from Example 1 are dispersed in 1 l of water. The mixture is adjusted to a pH of 8 using ammonia solution, the temperature is adjusted to 70° C., and 30 g of zinc nitrate, dissolved in 500 ml of water, are passed in with stirring. The mixture is then stirred for a further 2 h, and the solid is separated off by filtration. After the filter cake has been washed twice with water, the solid is dried at 200° C.

The phosphor coated in this way can then be employed for LEDs.

### Working Example 3

### Coating with Beryllium Oxide

50 g of the solid from Example 1 are dispersed in 1 l of water. The mixture is adjusted to a pH of 8 using ammonia solution, the temperature is adjusted to 80° C., and 20 g of beryllium nitrate, dissolved in 500 ml of water, are passed in with stirring. The mixture is then stirred for a further 2 h, and the solid is separated off by filtration. After the filter cake has been washed twice with water, the solid is dried at 200° C.

The phosphor coated in this way can then be employed for LEDs.

### Working Example 4

### Coating with Diamond by the CVD Process

The coating of articles with plasma CVD diamond is familiar to the person skilled in the art and is described, inter alia, in: Okuda et al., Science and Technology of Advanced Materials 8 (2007) 624-634. The process is described below:

5 g of a powder from 1 are heated at 300° C. for 6 hours in an air atmosphere in an oven. After cooling, the powder in a corundum boat is transferred in a low-pressure PE (plasma enhanced) CVD reactor consisting of a quartz tube. The diamond layers are deposited from a CH₄/H₂ plasma (13.56 MHz) at gas flow rates of 4.5 sccm (CH₄) and 75 sccm (H₂). The deposition time is 3 hours.

The coated phosphor can then be installed in the LED.

### Working Example 5

### Multiple Coating with SiO₂—ZnO—SiO₂—ZnO

The material from Example 2a is provided with a further double layer of SiO₂ and ZnO. To this end, 50 g of the material from Example 2 are dispersed in 750 ml of ethanol at 25° C. 15 ml of tetramethoxysilane are passed in over the course of 5 min with stirring. 80 ml of concentrated ammonia solution are then metered into the dispersion over the course of 30 min, and the mixture is stirred vigorously for a further 30 min. In a further step, 53 ml of tetraethoxysilane are metered into the mixture over the course of 60 min, and the mixture is stirred for a further 3 hours. The solid is separated off by filtration, and the filter cake is washed with ethanol and dried at 200° C. for 24 h. 50 g of this material are dispersed in 1 l of water. The mixture is adjusted to a pH of 8 using ammonia solution, the temperature is adjusted to 70° C., and 45 g of zinc nitrate, dissolved in 500 ml of water, are passed in with stirring. The mixture is then stirred for a further 2 h, and the solid is separated off by filtration. After the filter cake has been washed twice with water, the solid is dried at 200° C.

The phosphor coated in this way can then be employed for LEDs.

### Working Example 6

### Multiple Coating with SiO₂—BeO—SiO₂—BeO

The material from Example 2b is provided with a further double layer of SiO₂ and BeO. To this end, 50 g of the material from Example 2 are dispersed in 750 ml of ethanol at 25° C. 15 ml of tetramethoxysilane are passed in over the course of 5 min with stirring. 80 ml of concentrated ammonia solution are then metered into the dispersion over the course of 30 min, and the mixture is stirred vigorously for a further 30 min. In a further step, 53 ml of tetraethoxysilane are metered into the mixture over the course of 60 min, and the mixture is stirred for a further 3 hours. The solid is separated off by filtration, and the filter cake is washed with ethanol and dried at 200° C. for 24 h. 50 g of this material are dispersed in 1 l of water. The mixture is adjusted to a pH of 8 using ammonia solution, the temperature is adjusted to 80° C., and 30 g of beryllium nitrate, dissolved in 500 ml of water, are passed in with stirring. The mixture is then stirred for a further 2 h, and the solid is separated off by filtration. After the filter cake has been washed twice with water, the solid is dried at 200° C.

The phosphor coated in this way can then be employed for LEDs.

### Working Example 7

### Surface Functionalisation with Silane, Especially for Silicone Binder A

50 g of the material from Example 2a or 2b or Example 4a or 4b are suspended in 750 ml of water with vigorous stirring. The pH of the suspension is adjusted to pH=6.5 using 5% by weight H₂SO₄, and the suspension is heated to 75° C. 3 g of a 1:2 mixture of Silquest A-1110 [gamma-aminopropyltrimethoxysilane] and Silquest A-1524 [gamma-urea-propyltrimethoxysilane] are subsequently metered into the suspension over the course of 75 min with moderate stirring. When the addition is complete, the mixture is subsequently stirred for a further 15 min in order to complete the coupling of the silanes to the surface. The pH is corrected to 6.5 by means of 5% by weight H₂SO₄.

The suspension is subsequently filtered, and the solid is washed with deionised water until salt-free. The drying is carried out at 140° C. for 20 h. The phosphor powder coated in this way can be installed directly in the LED.

### Working Example 8

### Surface Functionalisation with Vinylsilane, Especially for Silicone Binder B

50 g of the material from Example 2a or 2b or Example 4a or 4b are suspended in 750 ml of water with vigorous stirring. The pH of the suspension is adjusted to pH=6.8 using 5% by weight H₂SO₄, and the suspension is heated to 75° C. 3.0 g of a 1:2 mixture of Silquest A-174 [gamma-methacryloxypropyltrimethoxysilane] and Silquest A-151 [vinyltriethoxysilane] are subsequently metered into the suspension over the course of 90 min with moderate stirring. When the addition is complete, the mixture is subsequently stirred for a further 15 min in order to complete the coupling of the silanes to the surface. The pH is corrected to 6.5 by means of 5% by weight H₂SO₄. The suspension is subsequently filtered, and the solid is washed with deionised water until salt-free. The drying is carried out at 140° C. for 20 h. The phosphor powder coated in this way can be installed directly in the LED.

### DESCRIPTION OF THE FIGURES

The invention will be explained in greater detail below with reference to working examples:

FIG. 1: shows an orthosilicate phosphor particle (1) which is embedded in a binder (for example silicone or epoxy resin) (shown as a white background) and sits on an LED chip (not shown). During operation of the LED and the associated evolution of heat (2) by the resin and silicate phosphor particle (1), the phosphor gradually loses luminance.

FIG. 2: shows an orthosilicate phosphor particle (1) coated with a coating (3) comprising a transparent material having a thermal conductivity of <20 W/mK, which serves as thermal protection screen. At least one second coating (4) comprising a transparent material having a high thermal conductivity of >20 W/mK lies on the first coating. This second coating conducts the heat away from the phosphor. Some particles (5) of the second coating of high thermal conductivity detach and are then dispersed in the binder (resin).

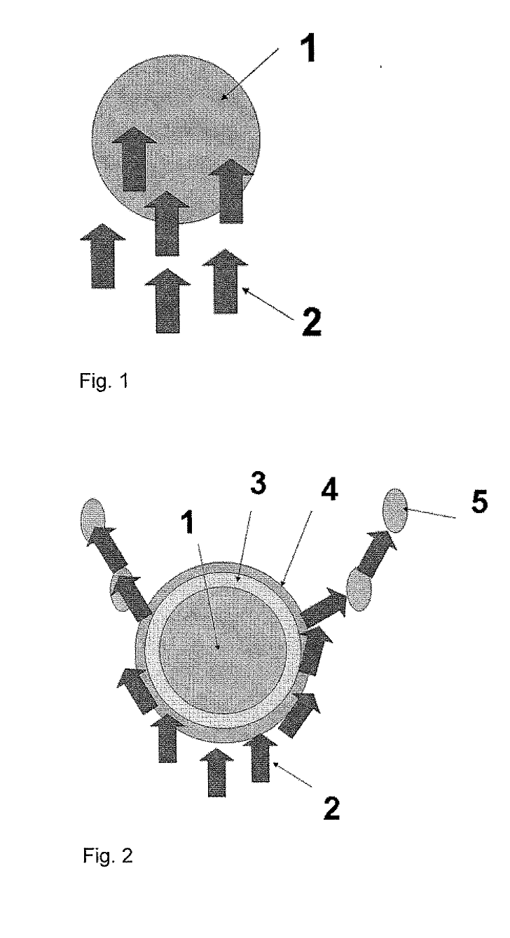

1. Surface-modified phosphor particles based on luminescent particles which comprise at least one luminescent compound selected from the group of the silicate phosphors, characterised in that at least one coating having a thermal conductivity of <20 W/mK and at least one second coating having a thermal conductivity of >20 W/mK have been applied to the luminescent particles.

2. Surface-modified phosphor particles according to claim 1, characterised in that the luminescent particles comprise at least one luminescent compound selected from the group
BaᵤSrᵥZn_{w}EuₓSiO₄ (I)
and/or
BaᵤSrᵥCa_{w}EuₓSiOₜ (II)
where u+v+w+x=2.

3. Surface-modified phosphor particles according to claim 1, characterised in that the coating having a thermal conductivity of <20 W/mK comprises oxides of Si, Zr, Ti and/or mixtures thereof.

4. Surface-modified phosphor particles according to claim 1, characterised in that the second coating comprises carbon layers, Al₂O₃, ZnO, MgO or BeO and/or mixtures thereof.

5. Surface-modified phosphor particles according to claim 1, characterised in that the first coating has a thermal conductivity of between 0.1 and 10 W/mK.

6. Surface-modified phosphor particles according to claim 1, characterised in that the second coating has a thermal conductivity of between 25 and 2500 W/mK.

7. Surface-modified phosphor particles according to claim 1, characterised in that the particle size of the phosphor particles is between 0.5 and 40 μm.

8. Surface-modified phosphor particles according to claim 1, characterised in that the coating having a thermal conductivity of <20 W/mK and the coating having a thermal conductivity of >20 W/mK are substantially transparent.

9. Surface-modified phosphor particles according to claim 1, characterised in that the coating having a thermal conductivity of <20 W/mK is amorphous and/or porous.

10. Process for the production of a surface-modified phosphor particle according to claim 1, characterised by the following steps:
a) production of a phosphor particle by mixing at least two starting materials and at least one dopant and thermal treatment at a temperature T>150° C.,
b) coating of the phosphor particle with a coating having a thermal conductivity of <20 W/mK in a wet-chemical or vapour-deposition process,
c) application of at least one further coating having a thermal conductivity of >20 W/mK.

11. Process according to claim 10, characterised in that the coatings are substantially transparent.

12. Process according to claim 10, characterised in that the first coating employed comprises nanoparticles and/or layers of oxides of Si, Zr, Ti, or combinations thereof.

13. Process according to claim 10, characterised in that the phosphor is prepared by wet-chemical methods from organic and/or inorganic metal, semimetal, transition-metal and/or rare-earth salts by means of sol-gel processes and/or precipitation processes.

14. Process according to claim 10, characterised in that the coating with at least one metal, transition-metal or semimetal oxide is carried out by addition of aqueous or non-aqueous solutions of non-volatile salts and/or organometallic compounds.

15. Process according to claim 10, characterised in that the second coating comprises carbon layers, Al₂O₃, ZnO, MgO or BeO and/or mixtures thereof.

16. Lighting unit having at least one primary light source whose emission maximum is in the range from 250 nm to 530 nm, preferably between 380 nm and 500 nm, where this radiation is partly or completely converted into longer-wavelength radiation by surface-modified phosphor particles according to claim 1.

17. Lighting unit according to claim 16, characterised in that 1 to 20% by weight of particles consisting of the material of the second coating of the surface-modified phosphor particles are dispersed in the ambient binder resin.

18. Lighting unit according to claim 16, characterised in that the light source is luminescent indium aluminum gallium nitride, in particular of the formula InᵢGaⱼAlₖN, where 0≦i, 0 is ≦j, 0≦k, and i+j+k=1.

19. Lighting unit according to claim 16, characterised in that the phosphor is arranged directly on the primary light source and/or remote therefrom.

20. Lighting unit according to claim 16, characterised in that the optical coupling between the phosphor and the primary light source is achieved by means of a light-conducting arrangement.

21. Lighting unit according to claim 16, characterised in that the light source is a material based on an organic light-emitting layer.

22. Lighting unit according to claim 16, characterised in that the light source is a source which exhibits electroluminescence and/or photoluminescence.

23. A method of using at least one surface-modified phosphor particle according to claim 1 as conversion phosphor which comprises converting the primary radiation into a certain colour point in accordance with the colour-on-demand concept.

24. A method of using at least one surface-modified phosphor particle according to claim 1 which comprises converting the blue or near-UV emission into visible white radiation.
